(19) United States
(12) Patent Application Publication
(10) Pub. No.: US 2011/0276922 A1
(43) Pub. Date: Nov. 10, 2011

(54) Method and System for Video Interaction Based on Motion Swarms

(76) Inventors: Jeffrey Edwin Boyd, Calgary (CA); Quoc Ai Nguyen, Calgary (CA); Christian Johann Jacob, Calgary (CA); Gerald Hushlak, Calgary (CA)

(21) Appl. No.: 12/775,345

(22) Filed: May 6, 2010

(51) Int. Cl. G09G 5/00; G06F 3/048

(52) U.S. Cl. 715/833; 345/156; 715/764

(57) ABSTRACT

A system and method for generating a video display suitable for interaction with a public audience or group. The system comprises one or more video capture devices for capturing a scene, a module configured to extract one or parameters that describe a field of motion in the scene, and a module configured to generate a plurality of particles or a swarm of particles that are responsive or react to the motion field.

### FIELD OF THE INVENTION

The present application relates to image processing, and more particularly to a method and system for generating an interactive video display.

### BACKGROUND OF THE INVENTION

Event organizers often try to incorporate the audience into the event, for example, a concert, television show, sporting event. By engaging the audience, the organizers give people a sense of participation, reinforcing the notion that the audience is important to the event. In many cases, the mood of the audience can determine the success of an event. Therefore, many event organizers devise methods to engage an audience to keep them happy and entertained.

At sporting events, organizers typically try to engage their audiences. For example, mascots interact with the audiences and influence them to cheer for a team. Video screens cue audiences to clap and make noise. To further reinforce the event, video footage of the excited and cheering audience is often displayed on the video screens.

Video systems can provide a mechanism for interacting with art. While video systems may be inexpensive, easy to install, and typically impose few physical constraints, a public space presents a complex environment for video analysis systems. For instance, the number of people seen by a camera can vary from none to many. For instance, there may be motion in the background. In addition, light and weather conditions may vary. The clothing worn by members of the public subject of the video system may also vary. It will be appreciated that for effective interaction, a video system needs to accommodate these factors.

Interaction becomes even more difficult when the art is viewed by groups of people, for example, spectators at a sports event watching a video display while interacting with and manipulating the display with their movement or other motion. In this example, an interaction based video system must address the public space factors (as described above) in addition to scene complexity which arises from the number of people interacting (e.g. providing motion inputs) and the number of people not interacting.

Audience motion and behavior is complex, and accordingly, there still remains a need for improvements in the art.

### SUMMARY OF THE INVENTION

A method for video interaction is presented. In one embodiment, the method includes generating a motion field. The method also includes simulating motion of a particle in said motion field. In a further embodiment, the method includes inputting an input associated with one or more humans. One embodiment involves generating an interaction based on the simulated motion of said particle and said input associated with one or more humans. Additionally, the method may include determining a user defined control parameter in response to the interaction.

In a further embodiment, the user defined control parameter is determined through an interface comprising video-graphic interface control. For example, the video-graphic interface control may be a slider. The video-graphic interface control may also be a button or a dial. In certain embodiments, the video-graphic interface control may comprise a menu. For example, the menu may include a video-graphic interface control selected from the group of graphical interface controls consisting of a slider, a button, and a dial. In another embodiment, the video-graphic interface control may include a combination of a plurality of video-graphic interface sub-controls selected from the group of graphical interface sub-controls consisting of a slider, a button, and a dial.

A system for providing interaction between one or more participants and an image display is also presented. In one embodiment, the system includes a video capture device configured to capture a scene including the one or more participants. The system may also include a module configured to extract one or more parameters associated with a field of motion in said scene, wherein said field of motion is associated with the one or more participants. In a further embodiment, the system may include a module configured to modify said scene in response to said field of motion. Additionally, the system may include a module configured to generate an image on the image display based on said scene as modified by said field of motion. In still a further embodiment, the system may include a module configured to determine a user defined control parameter in response to the field of motion.

The various modules may be hardware defined modules. For example, the modules may be implemented in a processing device in response to computer instruction provided by a computer program product. In particular, the modules may be implemented by a suitably configured processor, Programmable Logic Device (PLD), Field Programmable Gate Array (FPGA), or the like.

In a further embodiment, the user defined control parameter may be determined through an interface comprising video-graphic interface control. The system may also include a video-graphic interface control module. The video-graphic interface control module may provide a user interface for interaction with a user. The user interface may additionally provide feedback to a user, e.g., through a graphically displayed widget or component. For example, the video-graphic interface control may include a slider, a button, or a dial. The video-graphic interface control may also include a menu. The menu may be comprised of various sub-controls, e.g., the slider, button, or dial.

A tangible computer program product comprising computer readable instructions, that when executed by a computer, cause the computer to perform certain operations is also presented. In one embodiment, the operations may include generating a motion field, simulating motion of a particle in said motion field, inputting an input associated with one or more humans, generating an interaction based on the simulated motion of said particle and said input associated with one or more humans, and determining a user defined control parameter in response to the interaction.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

Reference will now be made to the accompanying drawings which show, by way of example, embodiments according to the present invention, and in which:

FIG. 1 shows in diagrammatic form a system for generating an interactive video display according to an embodiment of the present invention;

FIG. 2 shows in flowchart form a method for generating an interactive video image according to an embodiment of the present invention;

FIG. 3 shows in flowchart form a method for extracting a motion field according to an embodiment of the present invention;

FIG. 4 shows in flowchart form a method for interacting with a motion swarm of particles attracted to motion, according to an embodiment of the present invention; and

FIG. 5 shows in flowchart form a method for interacting with a motion swarm of particles repelled by motion, according to an embodiment of the present invention.

FIGS. 6A-D illustrate various embodiments of a video-graphic control.

FIGS. 7A-E are screen-shot diagrams illustrating a user interacting with various embodiments of a video-graphic control.

FIG. 8 is a schematic block diagram of one embodiment of a computer system adapted to perform the operations of the methods described herein.

Like reference numerals indicate like or corresponding elements in the drawings.

### DETAILED DESCRIPTION OF THE EMBODIMENTS

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system. Alan Freedman, “The Computer Glossary” 268 (8th ed. 1998). A module comprises a machine or machines executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

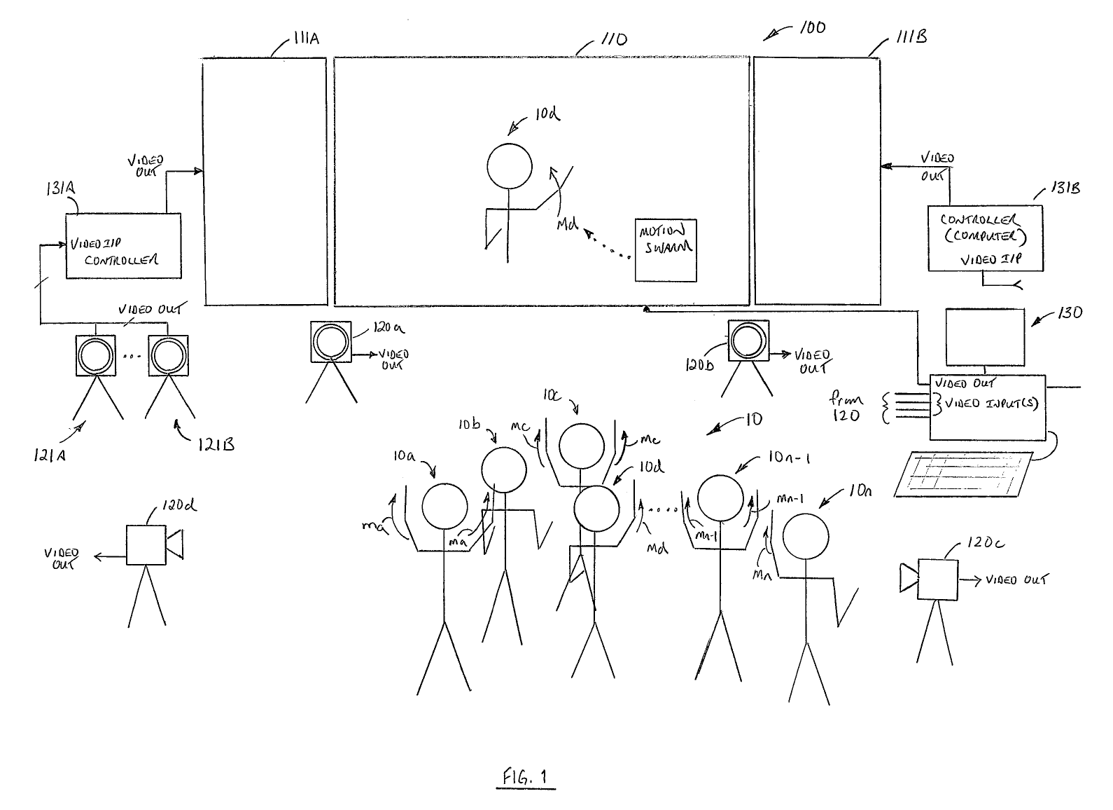

Reference is first made to FIG. 1, which shows in diagrammatic form a system for generating an interactive video display or image according to an embodiment of the invention and indicated generally by reference 100. As shown, the system 100 comprises a display screen 110, one or more image input devices 120 and a computer system indicated generally by reference 130. The image input devices 120, indicated individually by references 120a, 120b, 120c and 120d, may comprise a video camera and any other types of image capture or input devices. Each of the image input devices 120 provides a video output which is fed to or inputted by the computer system 130. The image input devices 120 and the computer system 130 may be implemented in known manner as will be within the understanding of one skilled in the art.

As shown in FIG. 1, the image input devices 120, e.g. one or more video cameras, are aimed or focused on an audience comprising one or more members, i.e. observers and/or participants indicated generally by reference 10. The participants or members 10, indicated individually by references 10a, 10b, 10c, 10d . . . 10n−1 and 10n, may comprise attendees at sporting event (for example, a hockey game or a football game) or people standing in front of a store front display having a video display monitor. As will be described in more detail below, the system 100 provides the capability for the participants to interact with an image or scene captured by the image input device(s) 120 and the result of interaction of the participant(s) is displayed in the form of one or more images on the display screen 110. The interaction may take a number of different forms. For example, as depicted in FIG. 1, participants 10a, 10c and 10n−1 have raised both arms, as indicated by references Ma, Mc and Mn−1, respectively, and participants 10d and 10n have raised only one arm, as indicated by references Md and Mn, respectively. As will be described in more detail below, the movement (or actions) of the participants 10 results in a motion field which is then applied to one or more swarms of image particles. The swarms of image particles comprise a mechanism which is responsive to the motion field and an image is generated based on the interaction of the motion field and the image is displayed on the display screen 110 for viewing by the participants or other members.

According to another embodiment, the system 100 may comprise one or more additional screens, for example, as denoted by references 111A and 111B in FIG. 1. According to another aspect, the system 100 may include one or more additional computing devices or controllers, for example, as denoted by references 131A and 131B in FIG. 1. According to one embodiment, the computers 131A and 131B are coupled to the respective display screens 111A and 111B. The computers 131A and 131 are configured to coordinate with the computer 130, for example, via software and/or a networked configuration to display the image over the multiple screens 110 and 111. According to another embodiment, the computers 131A and 131B receive video feed(s) from additional video input devices 121A and 121B. According to another embodiment, the computers 131A and 131B are coupled to respective display screens 111A and 111B and video feed(s) are provided by one or more of the video input devices 120.

In accordance with one aspect, the computer system 130 comprises a controller, or controller modules or components, which is configured to perform and provide the functionality as described in more detail below. The configuration may comprise the controller executing one or more computer programs, software modules, code components or objects configured to provide the functionality as described below.

According to one aspect, the system 100 comprises a video system providing for interaction with participants, e.g. an audience in a public place. The image input device(s) 120 capture a scene, e.g. images of the participants, and the computer system 130 is configured to define a field of motion in the scene and extract one or more parameters that describe the field of motion. The computer system 130 is configured to generate a swarm of particles that is responsive to the motion field. The motion field may comprise movements or actions performed by one or more of the participants. The parameters describing the motion field are then applied to the swarm of particles and the swarm responds to the motion field. The response, e.g. movement, of the swarm of particles is displayed to the audience giving the audience a view of the scene with the resulting participant interaction. According to another aspect, the computer system 130 is configured to generate one or more constraints that may be placed on the swarm of particles to control the response of the swarm.

According to an embodiment, the motion swarm mechanism comprises one or more swarms of particles that are responsive, e.g. move, to a field. The field is generated or based on a motion history image or MHI. The motion history image (MHI) in known manner provides a representation of a field of motion that is independent of the number of people in the scene or the complexity of the scene.

In a motion intensity field the pixels indicate how recently a pixel has changed in intensity. For instance, brighter pixels comprise pixels that have changed more recently, and darker pixels comprise pixels that have not changed. In the context of the present application, changes in intensity are due to motion.

Let Tₖ(x) comprise a binary image that indicates whether a pixel at x=[x,y]^{T} changed significantly in a video frame k. The binary image Tₖ can be computed using adaptive background subtraction, for example, as follows:

$${T}_{k} = \{ \begin{matrix}1 & \vert {I}_{k} ( x ) - {\overline{I}}_{k} ( x ) \vert \geq τ \\ 0 & otherwise\end{matrix} \qquad ( 1 )$$

where Iₖ is the image at time k, ~Iₖ is I smoothed in time, and τ is a threshold that determines what intensity change is significant. The temporal smoothing of I over a wide time window allows the background to adapt to slow changes in scene illumination. A recursive, infinite impulse response (IIR) filter allows for computationally efficient smoothing over broad temporal windows.

The motion history image (MHI) at time k is determined according to a function Mₖ(x) as follows:

Mₖ=max(cTₖ(x),Mₖ₋₁(x)−1) (2)

where cTₖ(x)ε{0,c}. Accordingly, when a pixel changes, the corresponding pixel in the MHI is set to c, otherwise, the value is decremented, never going below zero. In this way, the constant, c, sets the persistence of the motion history.

In order to have the swarm particles respond in a more natural or predictable manner, the function Mₖ(x) for determining the motion history image is “smoothed” as follows:

Mₖ(x)=Mₖ(x) [symbol] G(x;σ) (3)

where [symbol] indicates convolution and G is a Gaussian kernel. It will be appreciated that this operation also serves to broaden the basin of attraction for particles as described in more detail below. In accordance with one aspect, a large value is selected for σ. (for example, in the range of 10%), and a recursive filter is utilized to provide a computationally efficient implementation for arbitrary values of σ.

It will be appreciated that in public places or with large audiences the motion field can be quite complex. According to another aspect, the motion history image or MHI is treated like a field and the gradient of the MHI is translated into a force that acts on the particles comprising the swarm.

According to one embodiment, the function xₖ=[x,y]^{T} defines the position of a particle, the function vₖ=[vₓ,v_{y}]^{T} defines the velocity of a particle, and the function pₖ=[pₓ,p_{y}]^{T} gives the momentum of a particle at time interval ₖ. The following equations may be used to simulate movement of a particle in response to a force F acting on it:

$${x}_{k} = {x}_{k - 1} + {v}_{k - 1} Δ t , \\ {p}_{k} = {p}_{k - 1} + {F}_{k} ( x ) Δ t , and \\ {v}_{k} = \frac{{p}_{k}}{m} , \qquad ( 5 )$$

where Δt is the time sample interval and m is the particle mass. In accordance with an embodiment, the particles forming the swarm comprise points with no mass, and m is treated as a tunable constant.

Accordingly, for a particle at position x, the force due to the motion field is

$${F}_{{M}_{k}} = ∇ \tilde{M} ( x ) \approx \frac{1}{2} ⌊ \begin{matrix}{\tilde{M}}_{k} ( {[ x + 1 , y ]}^{T} ) - {\tilde{M}}_{k} ( {[ x - 1 , y ]}^{T} ) \\ {\tilde{M}}_{k} ( {[ x , y + 1 ]}^{T} ) - {\tilde{M}}_{k} ( {[ x , y - 1 ]}^{T} )\end{matrix} ⌋ \qquad ( 6 )$$

If F=F_{M}_{ₖ}, then the particles will tend to move up the gradient of the motion history image (MHI). Since the brightest pixels in the motion history image represent the most recent occurrence of motion, particles in the swarm will tend to follow the motion. In another embodiment, the force can be changed to repel the particles, for example, by setting m<0, or letting F=F_{M}_{ₖ}.

According to another aspect, the system 100 provides the capability to introduce other or additional forces which can act on particles or the swarm particles. For example, in a manner similar to that described above for the motion intensity field or MHI. The forces may comprise friction and forces arising from the interaction of neighboring particles or particles in a neighboring region, as described in more detail below.

According to one aspect, the computer system 130 is configured (e.g. under the control of a computer program or software) to introduce a frictional force that acts on particles in the swarm. It will be appreciated that without friction, particles in the swarm will continue to accelerate and move faster and faster every time the motion field is encountered. The frictional force acts in opposition to the velocity of the particle and provides the capability to slow down the particles and to prevent particles from “shooting past” regions of motion, for example, if the particle motion is too high.

According to another aspect, the computer system 130 is configured to introduce limits on the momentum of particles. It will be appreciated that particles that move too fast are not conducive to interaction with the audience, i.e. it is difficult for people to keep up with them. According to an embodiment an upper limit and/or a lower limit is placed on the magnitude of the particle momentum. The upper limit or bound prevents the particle from moving too fast, and the lower bound prevents the particle from coming to a complete stop.

According to another aspect, the computer system 130 is configured to generate a “bounding box”. The bounding box provides a defined region or area within which the particles are allowed to move. According to one embodiment, the bounding box corresponds to the size of the image displayed, for example, on the display unit 110 (FIG. 1). According to another embodiment, bounding boxes are generated to define sub-images of interest. For example, in an interactive game between two groups of people, the computer system 130 is configured to generate a bounding box for the image region corresponding to each group. An example application of a bounding box is described in further detail below for the interactive “Hockey” simulation.

According to one aspect, the computer system 130 is configured to generate one or more “anchors” or “anchoring forces”. An anchor defines a position for a particle and the application of a force can be used to propel the particle to the anchor position. For example, a plurality of anchors can be used to distribute particles throughout an image. Without the anchors, the particles can simultaneously follow motion to one part of the image and leave large portions of the image unsampled, and therefore unavailable for interaction. According to one embodiment, the anchoring force is modeled by the system as a spring between the center position and the particle.

It will be appreciated that each of these mechanisms, i.e. friction, momentum limit(s), bounding box, and anchor points comprise tunable parameters in the system 130. Tuning the parameters can alter the behavior of the particles or the swarm and this in turn can alter the nature of the interaction with the audience or participants.

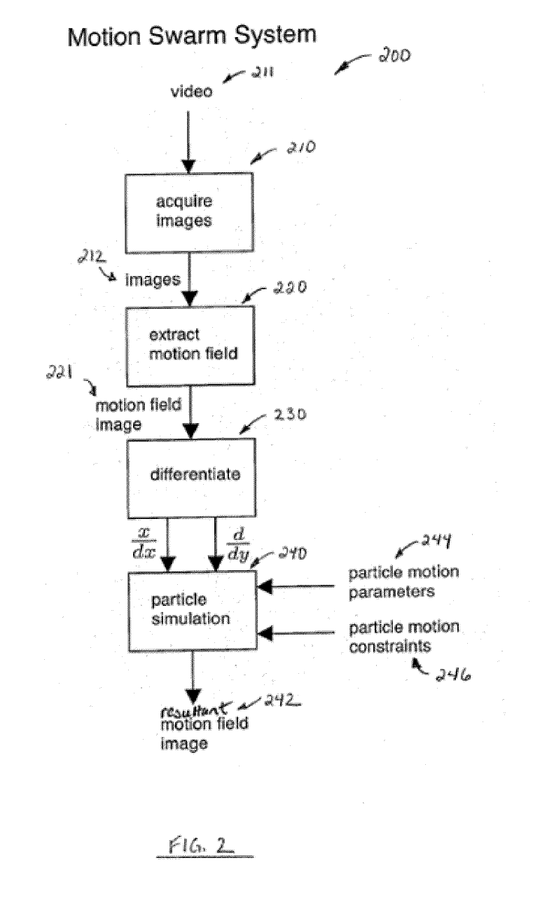

Reference is next made to FIGS. 2 to 5 which further illustrate the operation and implementation of aspects of the system 100 in accordance with various embodiments.

FIG. 2 shows in flowchart form a process for generating an image based on participant interaction. The process is indicated generally by reference 200. The first step in the process 200 as indicated by reference 210 comprises acquiring one or more images 212 of a scene. The images may be acquired from a video output 211 generated by one or more of the image capture devices 120 (FIG. 1). The captured images 212 are then processed by a module configured to extract a motion field image 221 as indicated by block 220. The motion field represents one or motion elements present in the captured images 212. The motion elements can be the result of movement by any one of a number of participants present in the scene and/or movement of an object (e.g. a ball) in the scene. For example, a motion element can comprise the participant 10a in FIG. 1 raising both arms Ma. The captured image comprises pixels and according to an embodiment as described above, motion in an image is determined by detecting changes in the intensity of the pixels. As shown, motion in the extracted motion field image 221 is determined by applying a differentiation function in block 230. According to an embodiment, the differentiation function 230 determines force on an “x” and “y” coordinate basis. The force is applied to a plurality or swarm of particles to produce motion. The next step as indicated by reference 240 comprises a particle simulation which involves subjecting the particles or swarm to motion inputs and/or motion constraints, indicated generally by references 244 and 246, respectively. The motion inputs 244 may comprise inputs from other participants and the motion constraints may comprise friction forces, momentum limiters, bounding box definitions and other parameters as described above. The particle simulation operation 240 results in a motion field image 242 which can then be displayed on a display screen (for example, the display screen 110 in FIG. 1). According to an embodiment, the motion field image 240 may comprise an overlay which displayed together with another image of the scene.

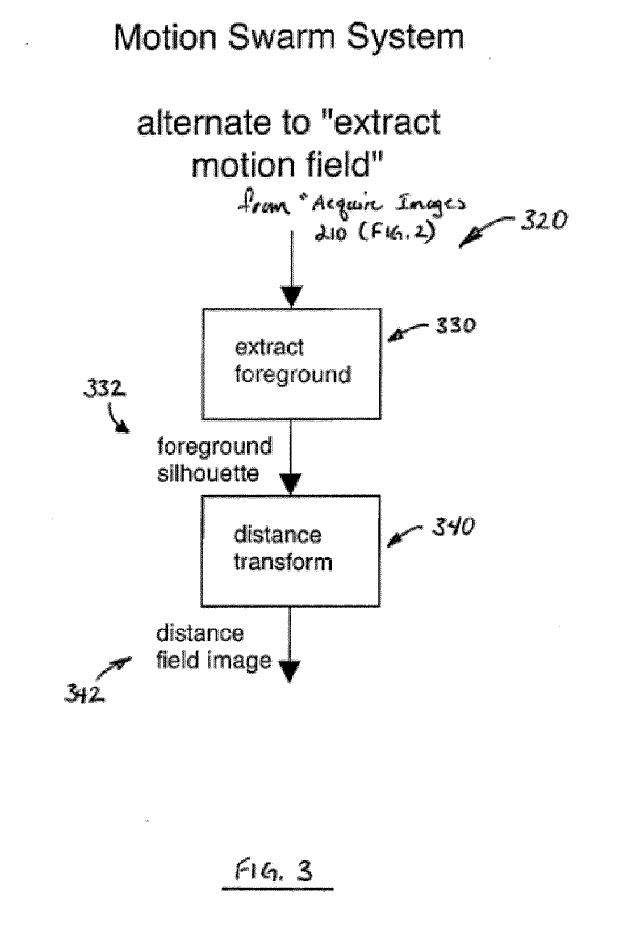

Reference is next made to FIG. 3, which shows a process for extracting a motion field according to another embodiment. The process of extracting a motion field is indicated generally by reference 320 and is implemented to be executed after the acquire images step 210 (FIG. 2). As shown, the first step involves executing a module configured to extract foreground data from the acquired images 212 (FIG. 2) and produce a foreground silhouette indicated generally by reference 332. The next step involves executing a module configured to apply a distance transform to the foreground silhouette 332 as indicated by reference 340. The output of the distance transform module 340 is a distance field image 342 which is then available for further processing as described above with reference to FIG. 2.

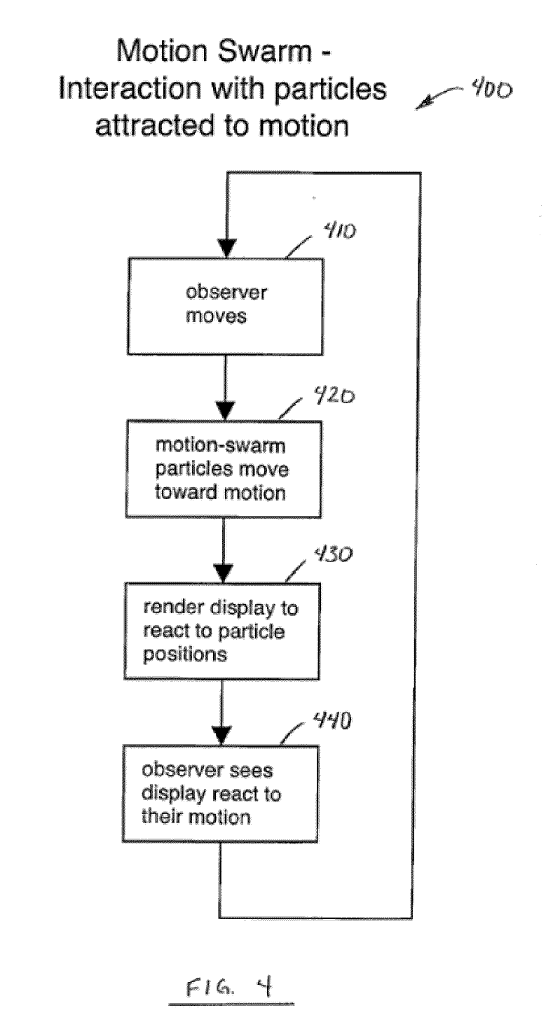

Reference is next made to FIG. 4, which shows a process for interacting with particles (i.e. a motion swarm) attracted to motion. The process is indicated generally by reference 400 and involves reacting to the motion of an observer (e.g. a participant 10 in FIG. 1) present in the scene and moving a swarm of particles toward the motion of the observer. The swarm of particles can comprise any form of visible object or graphic, for example, an arrow, a cartoon character, etc. As shown, the first step involves executing a module (for example, in software) configured to detect movement of the observer as indicated by reference 410. The next step involves executing a module configured to move the swarm of particles toward the motion of the observer (i.e. in reaction to the motion of the observer) as indicated by reference 420. The motion of the observer is determined, for example as described above, and the swarm of particles is attracted to, i.e. moves towards, the observer by using an anchor and a bounding box for swarm. The next step involves executing a module configured to render a display or image showing the movement of the particle swarm, i.e. the reaction of the particle swarm to the observer's motion, as indicated by reference 430. As described above, the movement of the particle swarm can be further controlled by applying constraints such as momentum limit(s) and/or a friction parameter. The next step involves executing a module configured to display the rendered image on a display screen as indicated by reference 440, and for example as depicted in FIG. 1 on the display screen 110. This allows the observer to see his/her interaction in the scene and in response make additional movements to change or repeat the interaction.

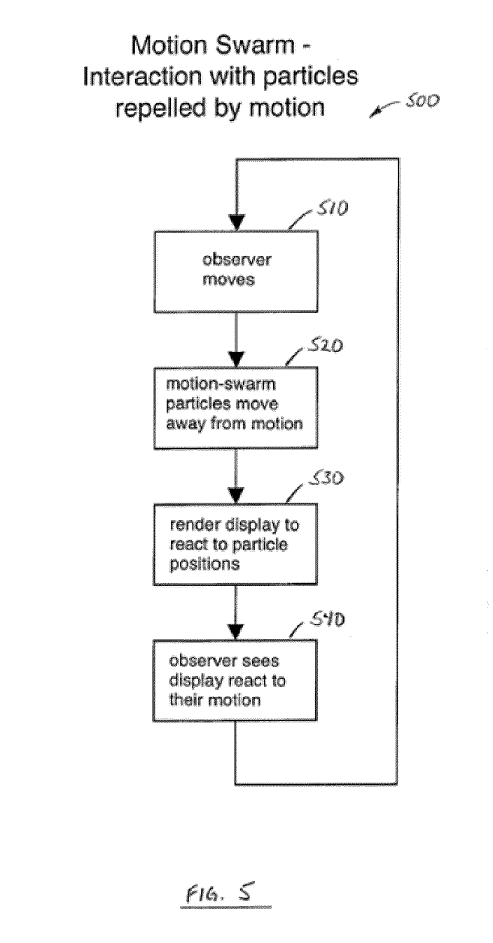

Reference is next made to FIG. 5, which shows another process for interacting with an image where the particles (i.e. a motion swarm) are repelled by motion. The process is indicated generally by reference 500 and involves measuring the motion of an observer (e.g. a participant 10 in FIG. 1) present in the scene and moving a swarm of particles away from the observer in reaction to the motion. With reference to FIG. 5, the first step involves executing a module (for example, in software) configured to detect movement of the observer as indicated by reference 510. The next step involves executing a module configured to move the swarm of particles away from the observer in reaction to the motion, as indicated by reference 520. The next step involves executing a module configured to render a display or image showing the movement of the particle swarm, i.e. the reaction of the particle swarm to the observer's motion, as indicated by reference 530. As described above, the movement of the particle swarm can be further controlled by applying constraints such as momentum limit(s) and/or a friction parameter. The next step involves executing a module configured to display the rendered image on a display screen as indicated by reference 540. Upon the observer to seeing his/her interaction in the scene, he or she may make additional movements to change or repeat the interaction.

The processes for generating and manipulating an interactive image as described above may be implemented in a computer program or software modules or objects as will be within the understanding to one skilled in the art. For example, according to one embodiment, the system is implemented in two modules: a video processing module and an artistic display module. The video processing module is implemented, for example, in Python and utilizes C- and assembly-based libraries to perform the fast inner-loop computations for the video processing and other related processing functions described above. According to one embodiment, the video processing module runs on a computer configured as a video server (for example, the computer 130 in FIG. 1). The video server is configured in a network with one or more other computers and exchanges XML documents and image data using HTTP protocol. In the context of the present application, the server is configured to broadcast or communicate source video, motion history image (MHI) data, and/or XML documents containing position information for the particles. The artistic display module is configured to run on or more computers networked with the server (for example, the computers 131 connected to the computer 130 via a network). The artistic display module is configured to communicate with the video server to acquire images and particle positions. According to one embodiment, the artistic display module includes a Breve™ simulation or a Quartz Composer™ software module for rendering the particles into swarm(s) for visualization. The artistic display module is configured (e.g. includes code components or modules) to allow the Breve™ simulation module to interact with the video processing module, such as receiving and reading XML documents from the video server. The Quartz Composer™ module is configured and used to provide three-dimensional image rendering. According to this aspect, the artistic display module renders a particle swarm for display which has been subjected to the motion field as described above. It will be appreciated that the mechanism or software/code modules for generating a swarm of particles may be implemented using other techniques.

Utilizing the system and techniques according to the present invention, the following audience interactive simulations may be performed.

“Music”—the simulated interaction allows an audience to produce music. According to the simulation, the audience is presented with an image of themselves, which is reversed left-to-right to give the effect of a mirror. The system is configured to superimpose upon the image a band (e.g. a blue band) at the top of the image and a set of balls (e.g. green balls). The balls are generated to correspond to the positions of particles generated/simulated by the video processing system. The system is configured to generate a force that repels the balls/particles. According to the simulation, the balls are propelled or moved around the display as members of the audience waves their hands or swats at the balls. The band at the top of the display is configured to operate as a virtual keyboard. When a ball hits the band, the keyboard plays music and the audience is provided with the sounds they generate. According to one embodiment, the sound generation function in the Breve simulation software may be used to generate the sounds in accordance with the simulation.

“Volleyball”—the simulated interaction involves an audience moving a ball back and forth as in a volleyball game. According to the simulation, the audience is presented with a mirror image of themselves on the display screen. Superimposed on the display is a single ball, and the system is configured to attract the ball to motion. As the ball moves, the audience sees that their image is rendered on a surface that moves with the ball. A tail flowing behind the ball is generated to emphasize the motion of the ball.

“Hockey”—the audience is presented with a display showing the names of rival hockey teams arranged in two columns. For each hockey team, four copies of the team logo are displayed below the name. In response to members of the audience moving, the system is configured to move the logos and according to one embodiment the system is configured to repel the logos in response to motion. According to the simulation, as the logos move, a brilliantly colored tail is generated and the team name is pulsed on the display. In this simulation, the audience is able to engage in a sort of competition where the object is to make their team name and logo the most animated. The system is configured to generate a motion particle for each logo, and the motion of the particle is constrained by a bounding box, for example, movement of the logo is constrained to one side or region/area of the display. For this simulation, the system is also configured to generate an anchor for each of the logos, for example, to maintain coverage of the audience.

“Spray Paint”—the audience is presented with an image of themselves on the display screen with one or more (e.g. three) superimposed balls. The system is configured so that the balls follow the motion of particles, and the balls function as virtual spray cans, i.e. spray painting the image of the audience appearing on the display screen. The particles respond or react to motion inputs (for example, from members of audience moving their arms or standing up) and the resulting motion of the particles is tracked by the balls to spray paint the image. According to one embodiment, where the balls are present, the video image is spray painted, and where the balls are not present the image is frozen, i.e. it appears as when last sprayed (or not sprayed).

In addition, by adding sets of constraints to the particle motion, one can build GUI-style widgets. Several of these widgets and the results of a small-sample pilot study to test them are described below. These various embodiments, and their equivalents, may be useful for video games and interactive theatre.

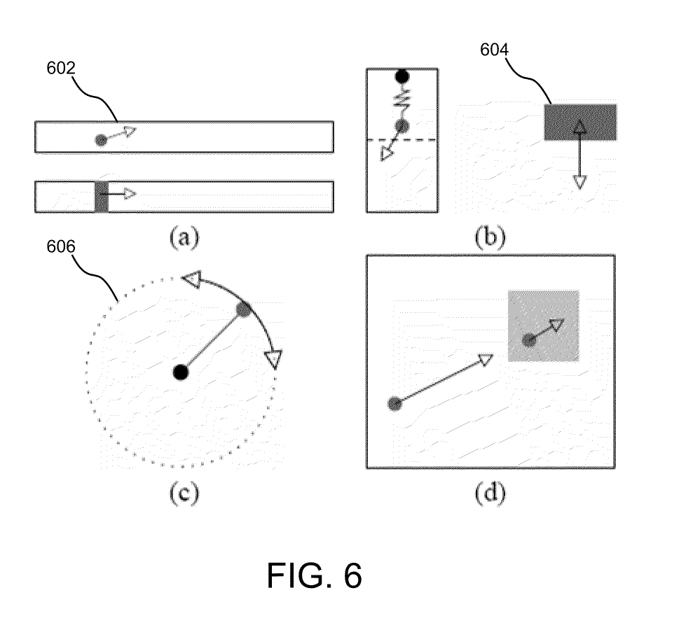

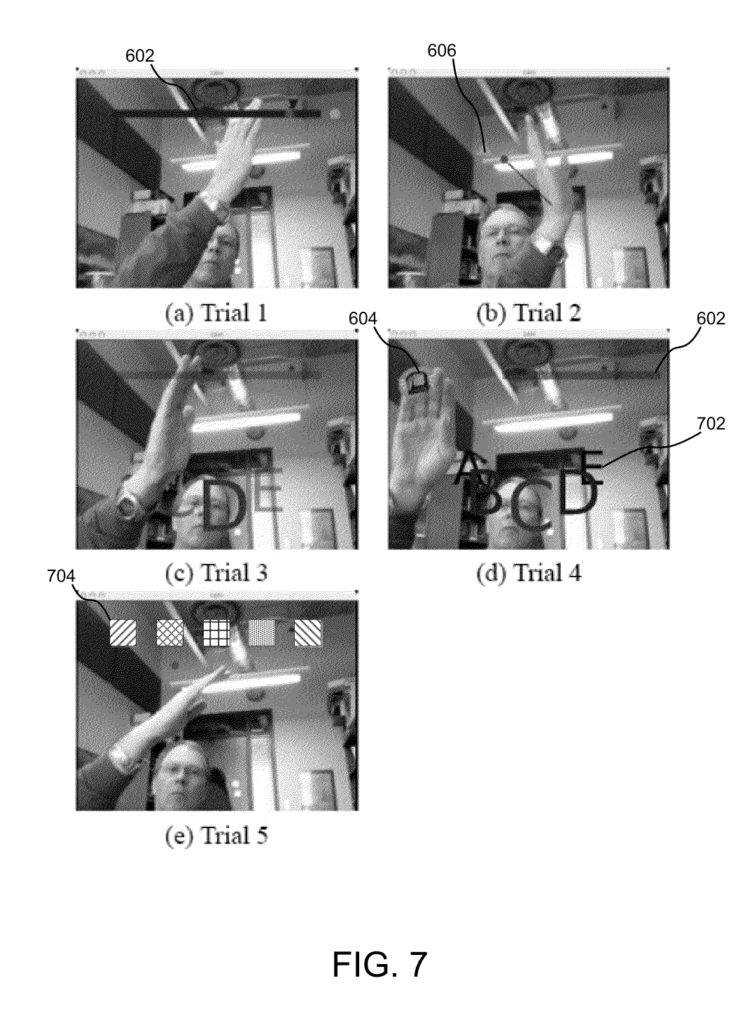

As an additional feature, the method described above may also include determining a user defined control parameter in response to the interaction. For example, the user defined control parameter is determined through an interface comprising video-graphic interface control (described in FIGS. 6-7). For example, the video-graphic interface control may be a slider 602. The video-graphic interface control may also be a button 604 or a dial 606.

In certain embodiments described in FIG. 7, the video-graphic interface control may comprise a menu 702. For example, the menu 702 may include a video-graphic interface control selected from the group of graphical interface controls consisting of a slider 602, a button 604, and a dial 606. In another embodiment, the video-graphic interface control may include a combination of a plurality of video-graphic interface sub-controls selected from the group of graphical interface sub-controls consisting of a slider 602, a button 604, and a dial 606.

A tangible computer program product comprising computer readable instructions, that when executed by a computer, cause the computer to perform certain operations is also presented. In one embodiment, the operations may include generating a motion field, simulating motion of a particle in said motion field, inputting an input associated with one or more humans, generating an interaction based on the simulated motion of said particle and said input associated with one or more humans, and determining a user defined control parameter in response to the interaction.

Motion swarm interaction with audiences works for several reasons. First, the measurement of the motion field need not be precise; it is enough to know where motion is and is not occurring in the image. Second, the mirroring of particle positions and the audience in the display provides a common coordinate system for the interaction without camera calibration. Finally, interactive art is not a demanding application; the interaction can be imprecise because the goal is entertainment and aesthetic value.

Applications of motion swarms involving, e.g., interaction, may benefit from constraining the motion of the particles. Careful use of these constraints may allow a user to build video interaction widgets in the style of common graphical user interfaces (GUI), thereby adding more precision to the interaction.

Motion swarms are particularly suited to interaction with Swarm Art where a simulated motion swarm particle acts as the world centre for a flock of simulated boids. People viewing the flock can modulate its motion by manipulating the motion swarm particle.

The particle motion must have some additional structure in the form of other constraining forces for interaction to be practical. The following describes a set of constraints that provide this structure.

Bounding Box: It is useful to constrain the particles to move only within a defined bounding box. At the very least, a bounding box the size of the images is necessary to keep the particles from going beyond the image boundaries. However, bounding boxes can also be useful to define smaller regions of interest.

Friction: Frictional forces act in opposition to particle velocity. Friction allows the particles to slow down in the absence of motion, and can prevent particles from shooting past regions of motion because their velocity is too high, confounding interaction.

Velocity Bounds: In addition to using friction to limit particle speed, we also can place bounds on the particle velocity.

Anchors: We can anchor a particle by defining a central position and adding a force that propels the particle toward that position. This is useful when we want to maintain a distribution of points throughout the image space. We model the anchoring force as a spring between the anchor position and the particle.

Pivots: In an elaboration on an anchor, we can force the particle to remain a fixed distance from an anchor point. This allows the particle to move in a circular orbit, responding to tangential forces generated by the motion field.

Each of these constraints may have tunable parameters that affect the behavior of the particles tangibly. Part of creating a motion swarm system may include tuning these parameters to get the right feel for the interaction.

In a further embodiment, motion-swarm interaction may be extended to achieve a more precise, GUI-style interaction. FIG. 6 shows the configuration of four example widgets that can be constructed from motion swarm particles. The first, FIG. 6(a) illustrates a horizontal slider widget built on a narrow bounding box. The particle is free to move within the two dimensional box (above), but due to the elongation of the box, the motion is mostly horizontal. Motion can push or pull the slider across the box. If only the horizontal position of the particle is displayed, the particle moves as a horizontal slider (below).

Horizontal slider: The first trial widget was a horizontal slider as shown in FIG. 6(a) using a kinetophobic particle. One of ordinary skill in the art will recognize additional slider configurations, including vertical sliders and diagonal sliders. FIG. 7(a) shows the slider in operation. Users were asked to move the slider from its left-hand extent to the right until it was aligned with a marker on the right-hand side. When the slider lined up, a disc-shaped indicator on the right became green.

FIG. 6(b) shows a button widget. A kinetophilic particle anchored at the top of a small box is free to move in two dimensions (left). Motion near the particle pulls it down. When the particle crosses a horizontal threshold it activates a switch, rendered to move up and down only (right). In order to prevent multiple activations, the switch is disabled until the particle returns above the threshold.

Dial: FIG. 7(b) shows a dial widget made from a kinetophobic particle rotating about a pivoting anchor (FIG. 6(c)). The display showed the particle and a line through the anchor to the particle. Subjects were timed while moving the particle from the right-hand side of the circle to the indicator on the upper left-hand side.

FIG. 6(c) shows a dial widget. A particle rotates about its pivot anchor. The angular position of the particle allows motion to set angular input.

In FIG. 6(d), a particle is free to move about the display in two dimensions. Regions of the display that correspond to selections or actions have high coefficients of friction. The particle moves quickly until it is directed to a high-friction region where it slows, and in the absence of motion, comes to a stop, thereby selecting/activating the box.

Variations on these themes extend the possible interactions. Dividing a slider into discrete positions allows one to select menu items. Kinetophobic versus kinetophilic particles also change the nature of the interaction, but in general kinetophobic particles are more useful: kinetophilic particles stick to motion, preventing a person from releasing a particle.

For example, FIG. 7(c) shows a horizontal slider widget as used in the first trial, but with a menu consisting of the letters A through F displayed below. As the slider moves, the menu items appear to rotate through the display. The slider is divided into intervals within which the menu sticks to a single item. The effect is that within a range of slider motion, the menu item is stable. Users started with item A selected and were asked to select item E.

FIG. 7. Screen grabs of sample interaction trials: (a) a horizontal slider, (b) a rotary dial, (c) a horizontal slider operating a menu, (d) a horizontal slider and menu with activation button, and (e) a two-dimensional position mechanism.

Horizontal slider menu with button: It is useful, if not essential, to indicate the selection of a menu item by activating a button. FIG. 7(d) shows a variation on the previous menu that includes a button (FIG. 6(b)) in the upper left-hand corner. Users were asked to select the items B-A-D with a combination of slider and button activations, starting from item A.

Two-dimensional box selection: FIG. 7(e) shows the last trial widget, a particle with full freedom in two dimensions, and a set of high-friction boxes corresponding to item selections. Subjects were asked to maneuver the particle from the bottom center of the display to select the red box.

Table 1 summarizes the timing results for all five trials. Without a basis for comparison, it is difficult to say if these times are fast or slow, but with the exception of a couple of trials for one of the subjects, all subjects quickly and competently completed the tasks. We also observed a strong correlation between the subject's age and time to perform the tasks. This suggests a bias that favors younger users, but the sample is small, and the correlation was not there for all of the trials.

TABLE 1
Summary of times (seconds) for pilot study results.

| | Trial | | | | |
|---|---|---|---|---|---|
| | 1 | 2 | 3 | 4 | 5 |
| minimum | 5 | 3 | 7 | 14 | 5 |
| maximum | 35 | 21 | 16 | 52 | 19 |
| mean | 13.2 | 9.4 | 10.6 | 27.4 | 10.0 |
| median | 8 | 8 | 9 | 24 | 6 |
| rS | 0.36 | 0.82 | 0.97 | 0.82 | 0.03 |

rS is the Spearman rank correlation between trial time and subject's age.

Positive comments about the interface suggested that for most subjects the interfaces were fun, and especially younger subjects were quick to suggest an interface to a game of some sort. Clearly, the idea of applications in games generated excitement. One subject was comfortable enough with the interface to use his head to steer the particle in the last trial, while still accomplishing a time near the median.

In trial four, most subjects chose to use a single hand, perhaps because that was sufficient for the first three trials. Those who use their left hand to operate the button while using their right for the slider found the interface easier to use.

Trial four was also the most difficult and highlighted one of the difficulties with this approach. When subjects used a single hand, they had a tendency to activate the button accidentally while adjusting the slider. The interface reacts to motion and has no way to distinguish between deliberate and incidental motion.

One interesting observation in the last trial was that all but one subject manipulated the particle by separating degrees of freedom. That is, they would first move the particle horizontally (or vertically) to the correct position, and then finish the task by moving the remaining degree of freedom. The subject who chose to follow a straight line had the fastest time, but only by a small margin.

The potential for interacting with video games using this technology is the next step. Two-dimensional, arcade-style games are the low-hanging fruit, but it is anticipated that other, more elaborate game interfaces are possible. It is also speculated to take a step backward with motion-swarm widgets, and test them with an audience. Although operating a GUI en masse might be difficult, it suggests intriguing possibilities for interactive theatre.

The system described in FIG. 1 above may also include a module configured to determine a user defined control parameter in response to the field of motion. The various modules may be hardware defined modules. For example, the modules may be implemented in a processing device in response to computer instruction provided by a computer program product. In particular, the modules may be implemented by a suitably configured processor, Programmable Logic Device (PLD), Field Programmable Gate Array (FPGA), or the like.

In a further embodiment, the user defined control parameter may be determined through an interface comprising video-graphic interface control. The system may also include a video-graphic interface control module. The video-graphic interface control module may provide a user interface for interaction with a user. The user interface may additionally provide feedback to a user, e.g., through a graphically displayed widget or component. For example, the video-graphic interface control may include a slider 602, a button 604, or a dial 606. The video-graphic interface control may also include a menu 702. The menu 702 may be comprised of various sub-controls, e.g., the slider 602, button 604, or dial 606 as illustrated in FIG. 7.

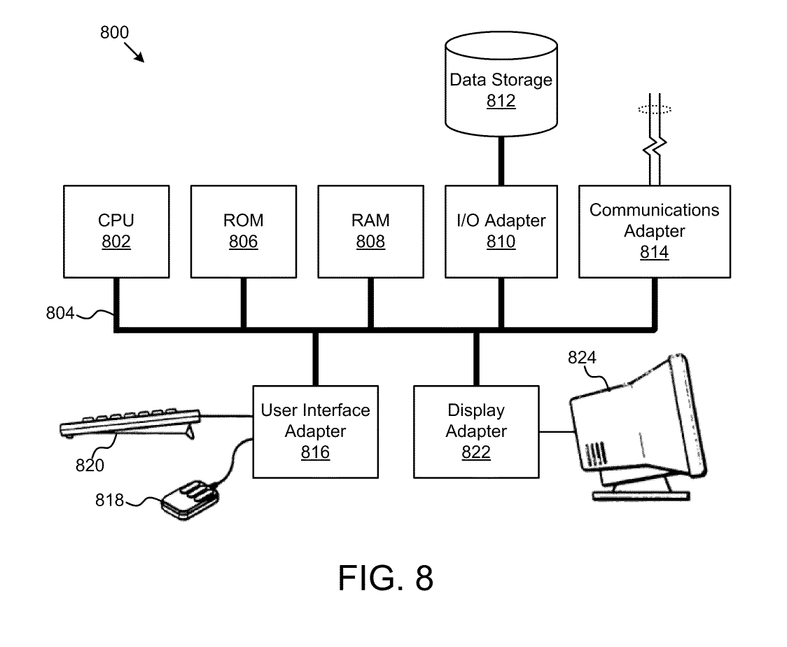

FIG. 8 illustrates a computer system 800 adapted according to certain embodiments of the controller computers 130, 131 illustrated in FIG. 1. The central processing unit (CPU) 802 is coupled to the system bus 804. The CPU 802 may be a general purpose CPU or microprocessor. The present embodiments are not restricted by the architecture of the CPU 802, so long as the CPU 802 supports the modules and operations as described herein. The CPU 802 may execute the various logical instructions according to the present embodiments. For example, the CPU 802 may execute machine-level instructions according to the exemplary operations described above with reference to FIGS. 2-5.

The computer system 800 also may include Random Access Memory (RAM) 808, which may be SRAM, DRAM, SDRAM, or the like. The computer system 800 may utilize RAM 808 to store the various data structures used by a software application configured for displaying video-graphic displays and determining inputs in response to a user's interaction with the video-graphic displays. The computer system 800 may also include Read Only Memory (ROM) 806 which may be PROM, EPROM, EEPROM, optical storage, or the like. The ROM may store configuration information for booting the computer system 800. The RAM 808 and the ROM 806 hold user and system 100 data.

The computer system 800 may also include an input/output (I/O) adapter 810, a communications adapter 814, a user interface adapter 816, and a display adapter 822. The I/O adapter 810 and/or user the interface adapter 816 may, in certain embodiments, enable a user to interact with the computer system 800 in order to input information for configuring the video-graphic displays. In a further embodiment, the display adapter 822 may display a graphical user interface associated with a software or web-based application for displaying the video-graphic displays.

The I/O adapter 810 may connect one or more storage devices 812, such as one or more of a hard drive, a Compact Disk (CD) drive, a floppy disk drive, a tape drive, to the computer system 800. The communications adapter 814 may be adapted to couple the computer system 800 to the network 106, which may be one or more of a LAN and/or WAN, and/or the Internet. The user interface adapter 816 couples user input devices, such as a keyboard 820 and a pointing device 818, to the computer system 800. The display adapter 822 may be driven by the CPU 802 to control the display on the display device 824.

The present embodiments are not limited to the architecture of system 800. Rather, the computer system 800 is provided as an example of one type of computing device that may be adapted to perform the functions of a server 102 and/or the user interface device 110. For example, any suitable processor-based device may be utilized including without limitation, personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

1. A method for video interaction, said method comprising the steps of:
generating a motion field;
simulating motion of a particle in said motion field;
inputting an input associated with one or more humans;
generating an interaction based on the simulated motion of said particle and said input associated with one or more humans; and
determining, using a processing device, a user defined control parameter in response to the interaction.

2. The method of claim 1, wherein the user defined control parameter is determined through an interface comprising video-graphic interface control.

3. The method of claim 2, wherein the video-graphic interface control comprises a slider.

4. The method of claim 2, wherein the video-graphic interface control comprises a button.

5. The method of claim 2, wherein the video-graphic interface control comprises a dial.

6. The method of claim 2, wherein the video-graphic interface control comprises a menu.

7. The method of claim 6, wherein the menu comprises a video-graphic interface control selected from the group of graphical interface controls consisting of a slider, a button, and a dial.

8. The method of claim 2, wherein the video-graphic interface control comprises a combination of a plurality of video-graphic interface sub-controls selected from the group of graphical interface sub-controls consisting of a slider, a button, and a dial.

9. A system for providing interaction between one or more participants and an image display, said system comprising:
a video capture device configured to capture a scene including the one or more participants;
a module configured to extract one or more parameters associated with a field of motion in said scene, wherein said field of motion is associated with the one or more participants;
a module configured to modify said scene in response to said field of motion;
a module configured to generate an image on the image display based on said scene as modified by said field of motion; and
a module configured to determine a user defined control parameter in response to the field of motion.

10. The system of claim 9, wherein the user defined control parameter is determined through an interface comprising video-graphic interface control.

11. The system of claim 10, wherein the video-graphic interface control comprises a slider.

12. The system of claim 10, wherein the video-graphic interface control comprises a button.

13. The system of claim 10, wherein the video-graphic interface control comprises a dial.

14. The system of claim 10, wherein the video-graphic interface control comprises a menu.

15. A tangible computer program product comprising computer readable instructions, that when executed by a computer, cause the computer to perform operations comprising:
generating a motion field;
simulating motion of a particle in said motion field;
inputting an input associated with one or more humans;
generating an interaction based on the simulated motion of said particle and said input associated with one or more humans; and
determining a user defined control parameter in response to the interaction.

16. The computer program product of claim 15, wherein the user defined control parameter is determined through an interface comprising video-graphic interface control.

17. The computer program produce of claim 16, wherein the video-graphic interface control comprises a slider.

18. The computer program product of claim 16, wherein the video-graphic interface control comprises a button.

19. The computer program product of claim 16, wherein the video-graphic interface control comprises a dial.

20. The computer program product of claim 16, wherein the video-graphic interface control comprises a menu.
